(19) United States
(12) Patent Application Publication
(10) Pub. No.: US 2007/0042638 A1
(43) Pub. Date: Feb. 22, 2007

(54) Prefabricating rack frame

(76) Inventor: Cheon Soon Choi, Chungcheongbuk-do (KR)

Correspondence Address: SHERIDAN ROSS PC, 1560 BROADWAY, SUITE 1200, DENVER, CO, 80202, US

(21) Appl. No.: 10/553,154

(22) PCT Filed: Apr. 14, 2004
(86) PCT No.: PCT/KR04/00686

§ 371 Date: Aug. 16, 2006

(30) Foreign Application Priority Data
Apr. 14, 2003 (KR) 10-2003-0023503
Apr. 14, 2004 (KR) 10-2004-0025632

(51) Int. Cl. H01R 13/66

(52) U.S. Cl. 439/541.5

(57) ABSTRACT

The prefabricating rack frame are comprised of a column and a cross member. The column is comprised of plural inner slots and plural outer slots. The inner slots are arranged in one or two vertical row in the center. The outer slots are formed at the respective outer side of each line of the inner slot, and each outer slot is located between the upper and lower row of the inner slot at equal interval. A location restrictor of the cross member is bent parallel to the upper horizontal flange, by which the location restrictor is fully contacted on the side surface of the column along the upper horizontal flange. A hole is provided at the vertical web so as to overlap any of the round openings. The round openings and the hole are for engaging the column and the cross member by the screw.

### TECHNICAL FIELD

This invention relates to a prefabricating rack frame that can be installed at a store, or warehouse, and a library, and on which different types of goods can be placed. The invention, specially, relates to the prefabricating rack frame that is made of only a column and a cross member without additional components, therefore, shakes can be prevented and structural stability can be attained.

### BACKGROUND ART

Most shelves can be used for storing or displaying goods in all kinds of mart or warehouse. The shelf has a structure in which several plates are stacked at a predetermined interval, and is composed by prefabrication for a facility of portage, assembly and disassembly.

Generally, to establish a prefabricating rack, an angle having plural slots can be cut at a predetermined length, and the angle is fastened by bolts and nuts through the bracket attached on the angle, thus making a shelf frame. A shelf, made of thin steel or wood plate, is placed on the horizontal angle.

However, such a prefabricating shelf needs plural bolts and nuts to lead troublesome in assembly and disassembly and needs much work time. This brings an increase of cost.

Furthermore, angles can be distorted by load of goods placed on the shelf after long-term usage. That causes plenty of problems such as an ugly appearance and instability.

Considering the above problems, an example of the rack frame enabling assembly without special fastening means is disclosed in the Korean Utility Model Publication No. 20-1996-0009841.

The conventional art is comprised of a column having parallel plural slots and a cross member being assembled with the column. A hook formed at the cross member is inserted into the slots of the column, and the cross member is pressed down, thus completing the assembly between the column and the cross member.

This technology has the advantage of easy assembly and disassembly since no additional fastening means is required.

However, the conventional art needs to have a gap between the hook and the slot when the hook is inserted into the slot, because it would lead to a difficult assembly if there was no gap. The gap causes a shaking of the cross member fitted into the column, and it brings structural instability of the prefabricating rack.

Meanwhile, European patent open-laid No. 0664094 (Jun. 26, 1995) discloses a technology of assembly between a column or upright and a cross member.

The technology, as shown in FIGS. 1 to 3, has the characteristic that three trapezoid slots 2 are formed at the center of the body of the upright 1, each longitudinal end of the cross member 3 has three hooks 4. Respective hooks of the cross member 3 are assembled with corresponding slots of the upright 1.

As another characteristic, in FIG. 4, a pair of trapezoid slot 2 is provided at the center of a body of the upright 1, each longitudinal end of the cross member 3 has two hooks 4 which are fitted into the corresponding slot 2 of the upright 1.

A bending portion 5 having a □ shape is provided adjacent to the hook of the cross member 3, and it enables the hook to make a tight contact with the slot 2 and the body of the upright 1, which devises structural stability of the assembly.

However, in this structure, since many steps of cutting and bending processes are required to form a hook, a bending portion, a protrusion, and an opening at each end of the cross member made by round pipe, the operation is troublesome and needs much time. There is also a concern about bad quality production owing to dimensions error of each component.

Specially, as shown FIG. 3, the hook of cross member is inserted into only one row, and it can prevent an “A” arrow movement, but not a “B” arrow movement. It causes a problem about the instability of a prefabricating rack frame.

### DISCLOSURE OF INVENTION

Accordingly, the present invention has been made keeping in mind the above problems occurring in the prior art, and an object of the present invention is to provide a prefabricating rack frame in which no special fastening means such as bolt and nut are used for the assembly of a column and a cross member, and more than 2 couplings are provided at the assembly of a column and a cross member. The present invention has more rigid assembly force than any prior art, and secures the isolation of a shaking of forward/backward, right/left direction and the structural stability, and also shows satisfactory appearance.

Another object of the present invention is to provide a prefabricating rack frame, by which it can able to possible that the manufacturing of each component can be done by a single process of cutting and bending, thus providing considerable effect in workability and productivity.

In order to accomplish those and these objects, the present invention has characteristic in which; a prefabricating rack frame comprises a column made of a steel square tube, a cross member made of a bent steel plate, by which a square is formed, and multiple shelf plates are placed. The prefabricating rack frame is comprised of; the column having plural inner slots, and plural outer slots, in which the inner slots are longitudinally formed along a middle portion of at least one surface of the column, and are arranged in one or two row in the center, the outer slots are formed at the respective outer side of each line of the inner slot, and each outer slot is located between the upper and lower row of the inner slot at equal interval; the cross member having a vertical web, an upper/lower horizontal flange which are contacted on the outer surface of the column, and plural inner/outer hooks, the inner/outer hooks are formed at each longitudinal end of the vertical web and are rectangularly bent toward the extending direction of the horizontal flange, thereby each inner/outer shook is inserted into the inner/outer slot provided at any one side of the column, and is firmly engaged into the respective slot.

Further, it has another characteristic in that the cross member further has a location restrictor formed at the inside of the inner hook and bent parallel to the upper horizontal flange, by which the location restrictor is fully contacted on the side surface of the column along the upper horizontal flange.

Further, it has another characteristic in that the column has a pair of round openings formed at the outer side of each lowest inner slot in a parallel way, the vertical web has a hole which overlaps any of the round openings, in which the round openings and the hole are for engaging the column and the cross member by a screw.

Further, it has another characteristic in that the inner slots are arranged in two vertical rows and in the form of the three horizontal rows along the upper and lower side, and the inner slots and outer slots have a vertical rectangular form and each bottom of the rectangular slants to the vertical center line of the once side of the column; and the inner/outer hook has the same incline as the inner/outer slot, thereby the hooks are fully contacted on the side surface of the slots.

Further, it has another characteristic in that the inner slots are arranged in one vertical row and in the form of the three horizontal rows along the upper and lower side, and the inner slot has a trapezoid shape, in which the upper side is longer than the lower side, and the outer slots are configured in a vertical rectangular shape each of which inclines as the same slant of right/left side of the inner slot; and the inner/outer hook has the same incline as the inner/outer slot, thereby the hooks are fully contacted on the side surface of the slots.

Further, it has another characteristic in that a supporter having a depression is provided at each end of the upper horizontal flange, the supporter has a pair of traversal slots; a supporting member is nested on a pair of traversal slots,

### DESCRIPTION OF DRAWING

The above and other objects, features and other advantages of the present invention will be more clearly understood from the following detailed description taken in conjunction with the accompanying drawings, in which:

FIGS. 1 to 3 are schematic views illustrating a configuration of a conventional prefabricating rack frame;

FIG. 5 is a perspective view showing an assembly of a column and a cross member according to a first embodiment of the present invention;

FIG. 6 is an enlarged perspective view of the cross member according to a first embodiment;

FIGS. 7 to 9 are a front view, a top plan view, and a side sectional view showing an assembly of a column and a cross member according to a first embodiment, respectively;

FIG. 10 is an exemplary assembly view according to a first embodiment;

FIG. 11 is an enlarged perspective view of the cross member according to a second embodiment;

FIG. 12 is an enlarged perspective view of the cross member according to a third embodiment;

FIG. 13 is an enlarged perspective view of the cross member according to a fourth embodiment;

FIG. 14 is a perspective view showing an assembly of a column and a cross member according to a fourth embodiment;

FIG. 15 is a front view showing an assembly of a column and a cross member according to a fourth embodiment;

FIG. 16 is an exemplary assembly view of a rack frame and a shelf supporter placed on the rack frame according to a fourth embodiment;

FIG. 17 is a perspective view showing an assembly of rack frame components according to a fifth embodiment;

FIG. 18 is a front view of the column of FIG. 17;

FIGS. 19 and 20 is a front view and a top plan view showing an assembly of a column and a cross member of FIG. 17, respectively;

FIG. 21 is a side sectional view showing an assembly of a column and a cross member of FIG. 17;

FIG. 22 is a perspective view showing an assembly of a column and a cross member according to a sixth embodiment;

FIG. 23 is a front view of the column of FIG. 22; and

FIG. 24 is a front view showing an assembly of a column and a cross member of FIG. 22.

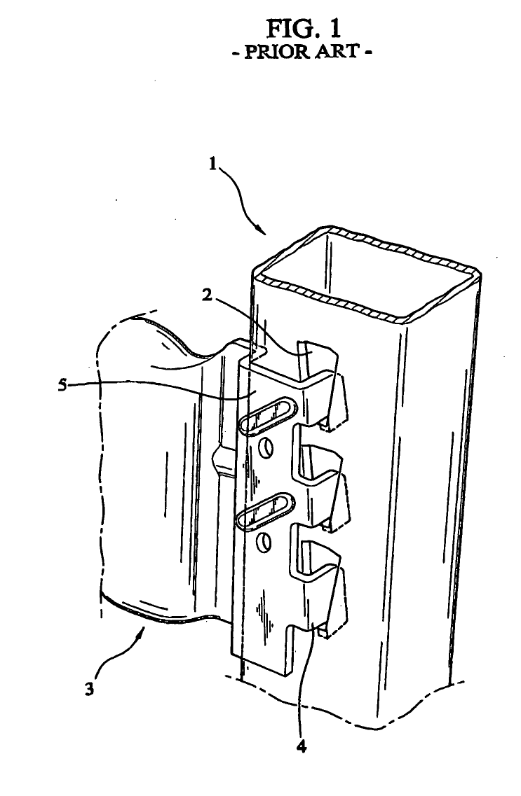

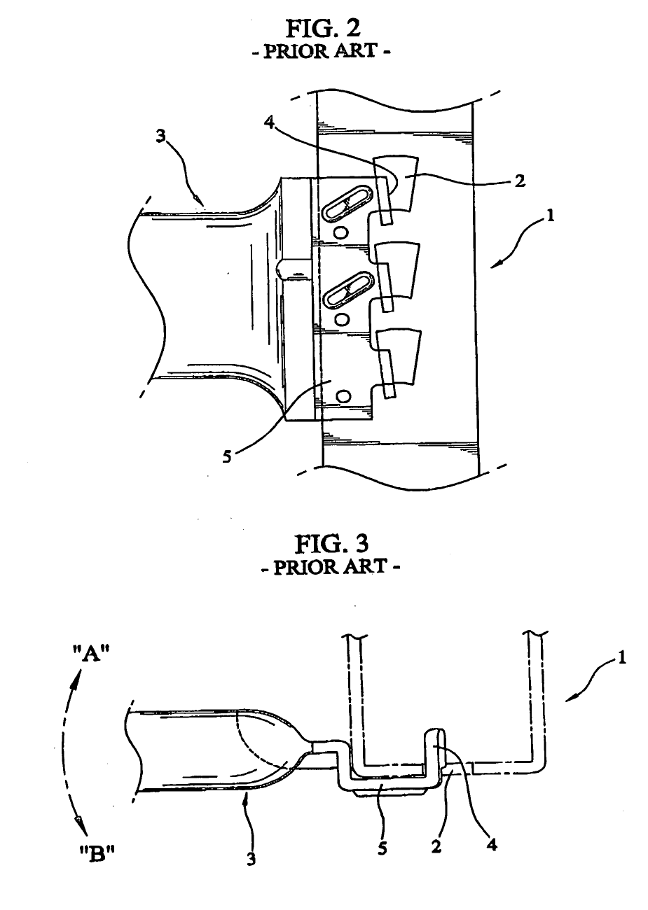

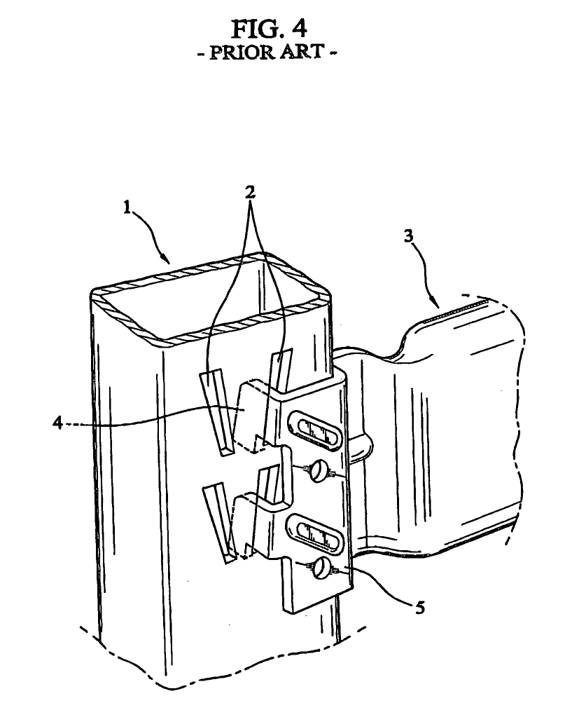

### BEST MODE

This invention will be further described by way of exemplary embodiments with reference to the accompanying drawings.

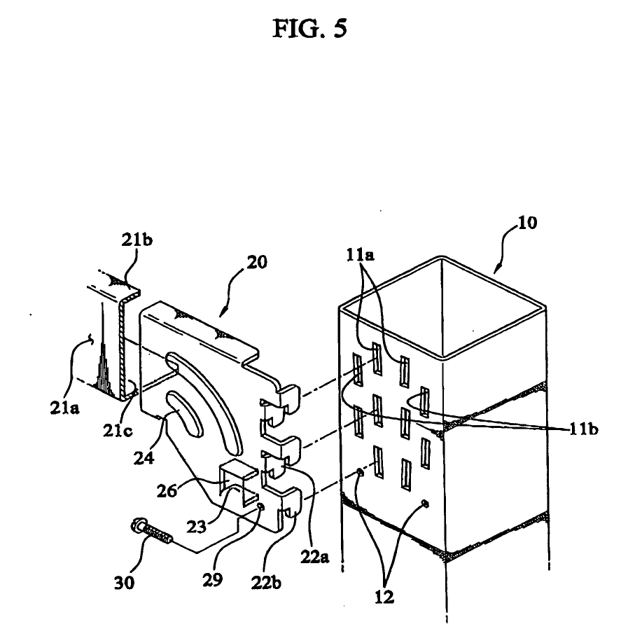

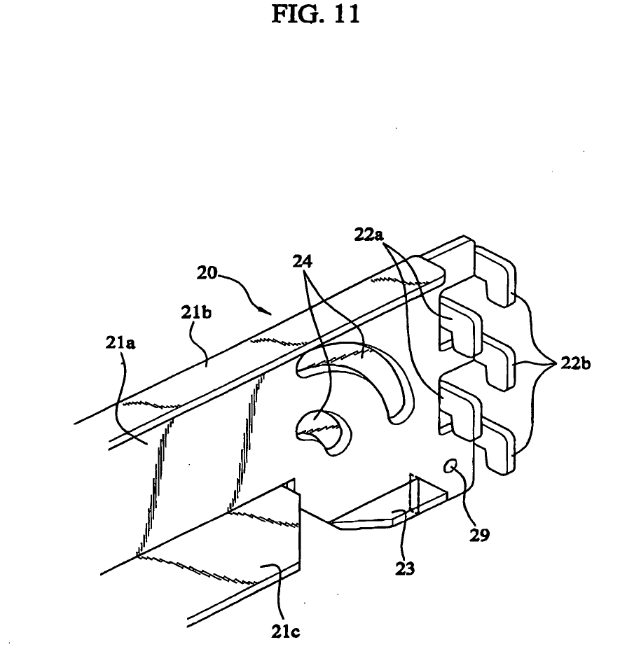

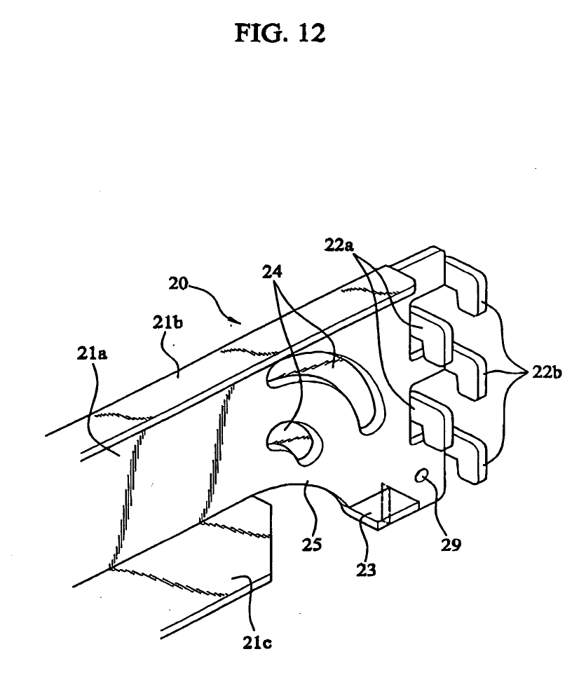

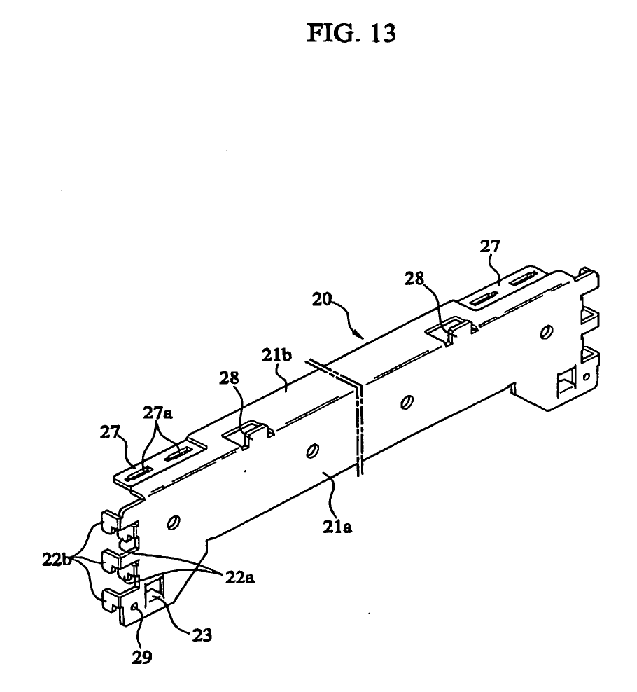

FIGS. 5 to 10 illustrate a prefabricating rack frame and its accompanying components according to a first embodiment of the present invention, FIG. 11 shows a perspective view of the cross member according to a second embodiment, FIG. 12 shows a perspective view of the cross member according to a third embodiment, FIGS. 13 to 16 illustrate a prefabricating rack frame and its accompanying components according to a fourth embodiment. The same components of the embodiments designate the same reference numbers.

As shown in the Figures, the prefabricating rack frame of the present invention are comprised of a column 10 made of a steel square tube, and a cross member 20 made of a bent steel plate, by which a square is formed, and multiple shelf plates P are placed.

The column 10 is comprised of plural inner slots 11a and plural outer slots 11b. The inner slots 11a are longitudinally formed along a middle portion of at least one surface of the column 10. The inner slots 11a are arranged in one or two row in the center. The outer slots 11b are formed at the respective outer side of each line of the inner slot 11a, and each outer slot 11b is located between the upper and lower row of the inner slot 11a at equal interval.

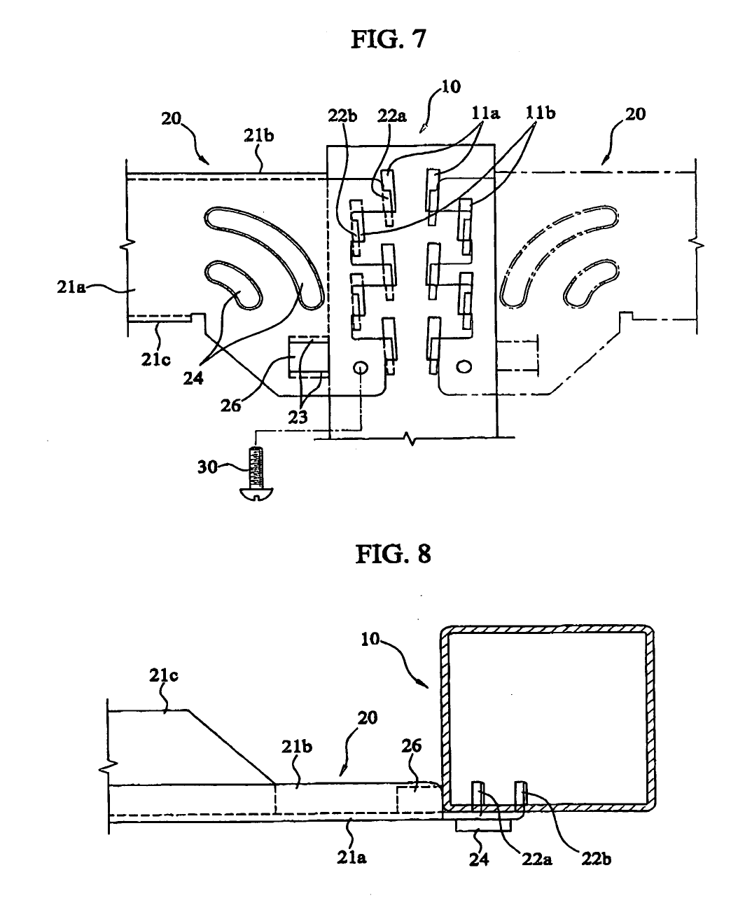

In the first embodiment shown in FIGS. 5 to 10, the inner slots 11a of the column 10 are arranged in 2 vertical rows, and in the form of the 3 horizontal rows along the upper and lower side. This illustrates that the shape of the inner and outer slots 11a, 11b have a vertical rectangular form and each bottom of the rectangle slants to the vertical center line of the one side of the column 10 (FIG. 7).

Such a column 10 is made by a square tube having a thick thickness, and is used for a large size prefabricating rack frame to sustain a relatively heavy load.

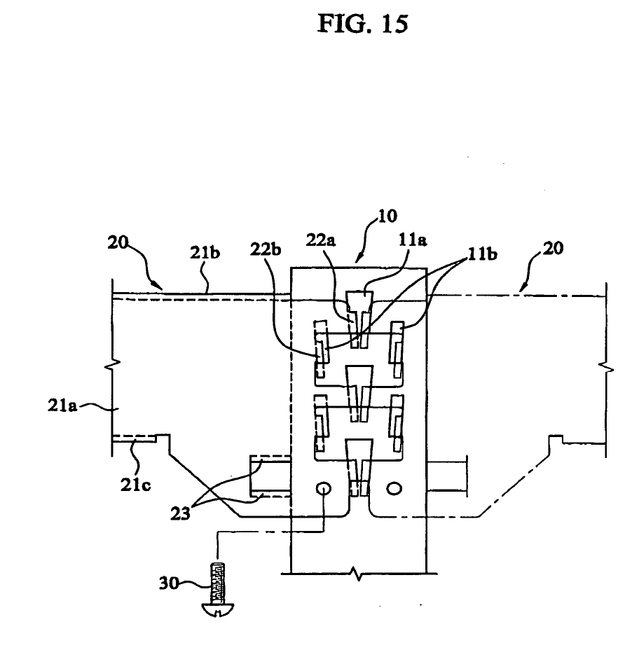

In the fourth embodiment shown in FIGS. 13 to 16, the inner slots 11a of the column 10 are arranged in one vertical row, and in the form of three horizontal rows in the upper and lower side. This illustrates that the shape of the inner slots 11a have a reverse trapezoid form having a longer upper width and a shorter lower width (FIG. 15).

The inner slot 11a of the column 10 can receive each outer hook 22b of the cross member 20 when each cross member 20 is inserted into respective side end of the column 10 as shown in FIG. 15. This configuration can be adapted to the cross member which is made by a relatively thin thickness pipe. That is used for a prefabricating rack frame of small and medium size to sustain light load.

The cross member 20 is comprised of a vertical web 21a, an upper/lower horizontal flange 21b, 21c, plural inner/outer hooks 22a, 22b, and a location restrictor 23. The inner/outer hooks 22a, 22b are formed at each longitudinal end of the vertical web 21a and are rectangularly bent toward the extending direction of the horizontal flange 21b, 21c. The location restrictor 23 is formed at the inside of the inner hook 22a and is bent parallel to the upper horizontal flange 21b.

Each side end of the cross member 20—in which the inner/outer hook 22a, 22b, the location restrictor 23, and a hole 29 are provided—has larger height than the middle portion of the cross member 20 to reduce material cost.

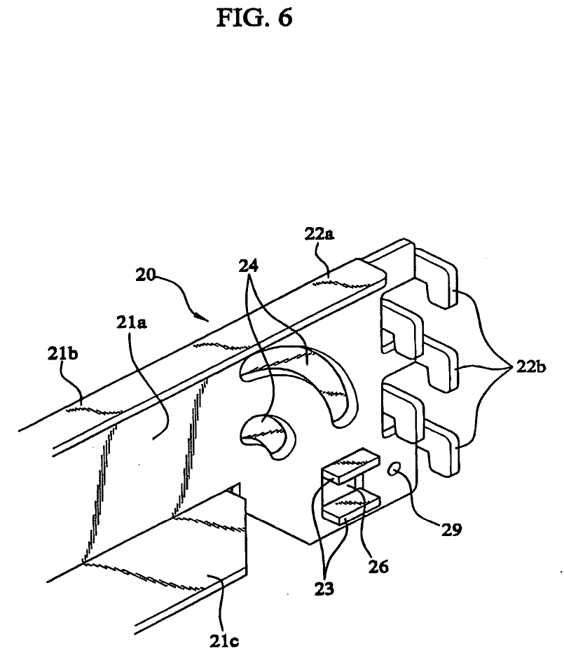

It is desirable that the cross member 20 of the fourth embodiment could be adapted as the cross member 20 of the first embodiment shown in FIGS. 5 and 6, and of the second embodiment shown in FIG. 11. That is, at least one reinforcement bead 24 is formed between each longitudinal end and the middle portion of the cross member 20. Preferably, the reinforcement bead 24 is formed as one of third embodiment shown in FIG. 12, and also a lower boarder 25 is provided between each longitudinal end and the middle portion of the cross member 20 in a rolling circular arc. Thus, each longitudinal end and the middle portion are connected to prevent the formation of local weak point.

Each inner/outer hook 22a, 22b is inserted into the inner/outer slot 11a, 11b provided at any one side of the column 10. Each hook is firmly engaged into its respective slot.

The inner/outer hooks 22a, 22b are made with the same slant as the inner/outer slot 11a, 11b. The hooks 22a, 22b are fully contacted on the side surface of the slots 11a, 11b when the hooks are inserted into the slots. This prevents the left-right freely movement of the hooks with the help of the horizontal flange 21b and the location restrictor 23.

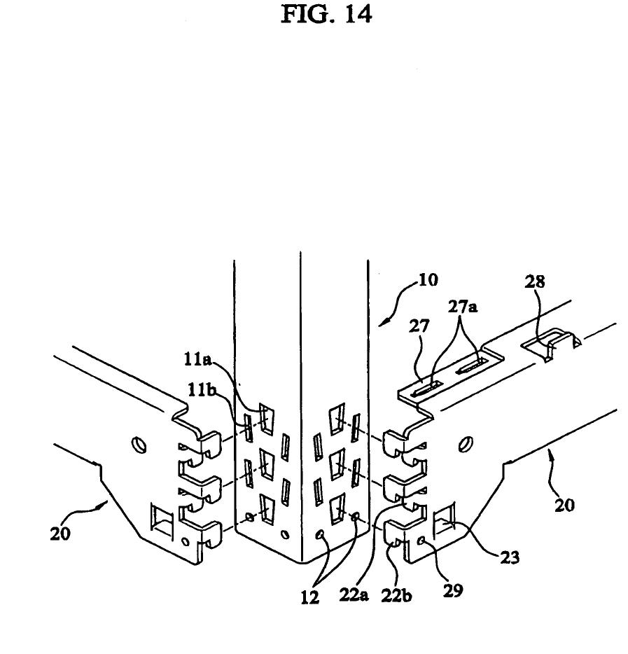

Furthermore, the inner vertical side of the inner/outer hook 22a, 22b is inclined outward along the direction from top to bottom of the hook, which facilitates easy fit (FIG. 14). Moreover, when each hook fits completely into each slot, the inner vertical end of the inner/outer hook contraposes the inner surface of the vertical web 21a against the wall of the column 10 so as to squash, which prevents the forward-backward free movement.

The location restrictor 23 tightly contacts the outer surface of the column 10 in company with the upper horizontal flange 21b.

As shown in FIG. 6, the rectangular opening 26 is formed at the middle position of the vertical web 21a, and each upper/lower part of the opening 26 is bent in a right angle, which configures the location restrictor 23.

Other embodiments (second and third) of the location restrictor 23 are shown in FIGS. 11 and 12, in which the partial lower portion of the vertical web 21a is bent at a right angle.

Meanwhile, as shown in FIG. 6, a pair of round openings 12 is formed at the outer side of each lowest inner slot 11a in a parallel way. A hole 29 is also provided at the vertical web 21a so as to overlap any of the round openings 12.

The round openings 12 and the hole 29 are for engaging the column 10 and the cross member 20 by the screw 30. The reason of parallel formation of the openings in the right-left side is that the screw 30 can be selectively engaged according to the installation condition of the cross member 20.

In other words, when the column 10 engages the cross member 20, as shown in FIGS. 5 and 14, the hole 29 is used for the screw 30 to bolt the corresponding opening 12. The screw fit prevents the unintentional separation of the column 10 from the cross member 20.

The inner/outer slot 11a, 11b and the round opening 12 are provided at two side surfaces of the upper/lower end of the column 10. That is, the slots and openings are formed at the same height at each surface facing each other or facing the surfaces adjacent to each other. The cross member 20 is assembled continually in forward/backward or left/right direction to make up a large shelf. The cross member 20 is installed at the middle height of the column 10 to make it a more rigid structure.

In the fourth embodiment shown in FIGS. 13 to 16, a supporter 27 is provided at each end of the upper horizontal flange 21b. The supporter 27 has a depression for supporting any shelf.

A pair of traversal slots 27a is formed at the supporter 27, on which a supporting member 40 is nested. The upper level of the supporting member 40 is the same as the upper horizontal flange 21b of the cross member 20.

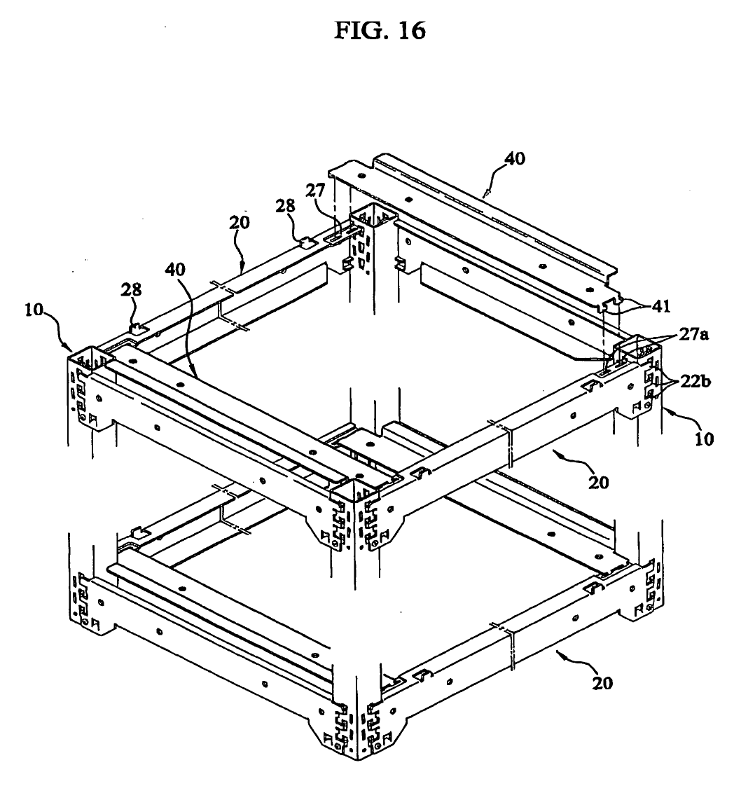

The supporting member 40 has a pair of hook 41 at each end thereof (FIG. 16). Each hook 41 is inserted into the traversal slot 27a so as to squash, which prevents easy separation.

A stopper 28 is provided at least two points of the cross member 20. The stopper 28 is configured as a partial cut-off of the upper horizontal flange 21b at the boarder between the vertical web 21a and the upper horizontal flange 21b. The cut-off portion is stretched upward along the extending direction of the vertical web 21a.

The above fourth embodiment is for supporting a wood plate. Since the upper surface of the upper horizontal flange 21b is even with the upper surface of the supporting member 40, a wood plate is stably nested. Thus, the stopper 28 prevents the wood plate from sliding off.

Hereafter, the assembly operation of the first embodiment according to the present invention will be described below.

First, as shown in FIG. 5, the inner/outer hooks 22a, 22b are inserted into one column of the inner/outer slots 11a, 11b, and the inner/outer hooks 22a, 22b are pressed down. Thus, the assembly is accomplished as shown in FIG. 7.

Now, it maintains that the surrounding edge of each inner/outer hooks 22a, 22b contacts onto the inner wall of the slots as shown in FIGS. 7 to 9. Also, the location restrictor 23 and the upper horizontal flanges 21b are tightly contacted with the outer surface of the column 10, which prevents the forward/backward and the right/left slight movement.

According to the above assembly, the hole 29 formed at the vertical web 21a can be matched with any of the round openings 12.

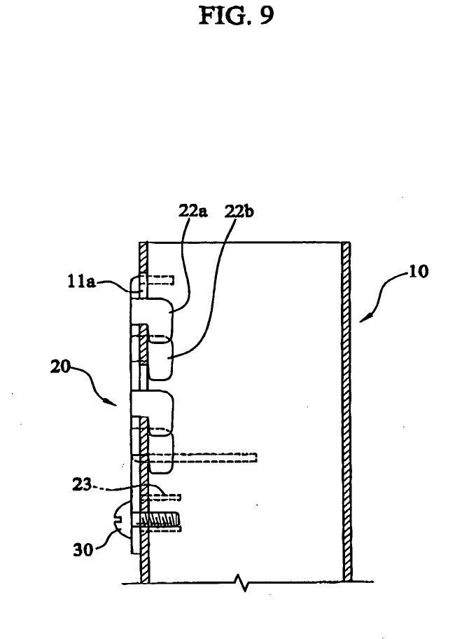

At this state, the screw 30 is engaged with the hole 29 and the round opening 12 as shown in FIG. 9, and the coupling between the column 10 and the cross member 20 is accomplished.

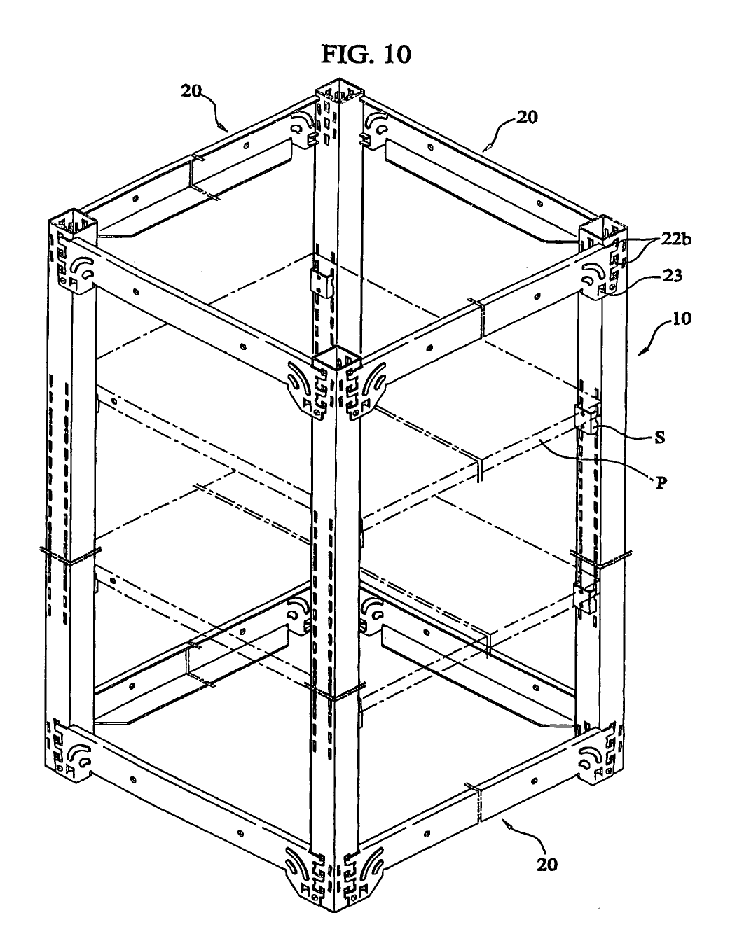

In the present invention, at every assembly portion between the column 10 and the cross member 20, the above operation is repeated, and the shelf frame having a rectangular shape is formed. As shown FIG. 10, a shelf supporter S is attached at the middle portion of the column 10, and the shelf plate P is laid on the shelf supporter S.

When the column 10 and the cross member 20 are disassembled from the finished shelf frame, the above procedure order can be reversed. First, the screw is disassembled from the hole 29 and the round opening 29. Next, the cross member 20 is pushed upward so as to extract the inner/outer hook 22a, 22b from the inner/outer slot 11a, 11b. Thus, the cross member 20 is easily disassembled from the column 10.

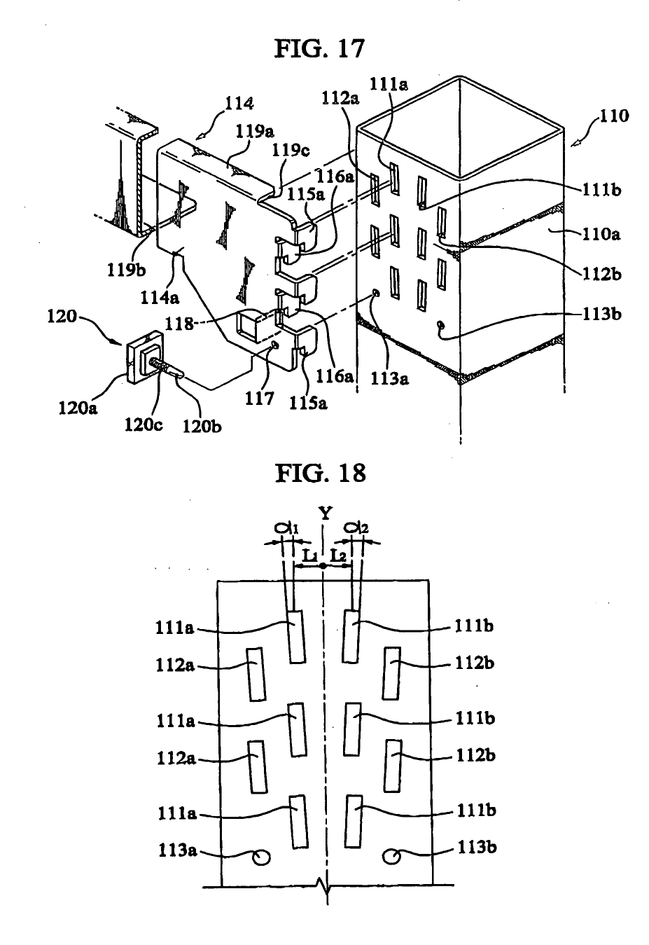

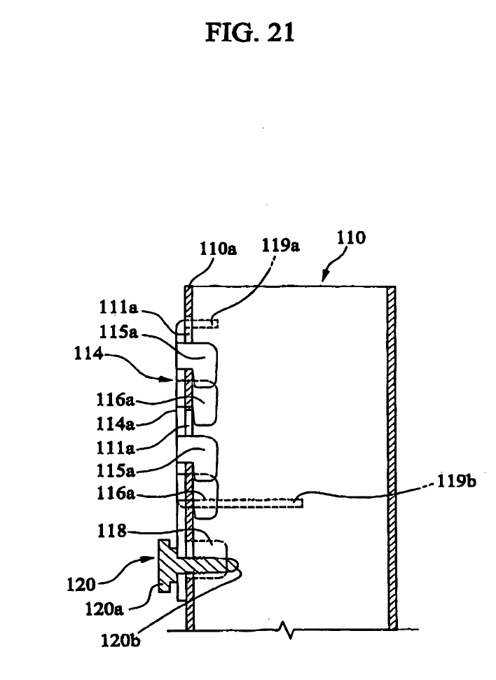

Hereafter, the technical components of the fifth embodiment will be described below with reference to FIGS. 17 to 21.

The column 110 is made of a thick material. The inner slots 111a, 111b are formed along a longitudinal direction. Each inner slot 111a, 111b has a distance L₁, L₂ from a center line Y of the body 110a. The outer slots 112a, 112b are provided at the outer side of each inner slot 111a, 111b and are provided between an upper inner slot 111a, 111b and a next below inner slot 111a, 111b at a predetermined interval. A pair of round openings 113a, 113b is provided below the lowest outer slot 112a, 112b.

The inner slot 111a, 111b and the outer slot 112a, 112b are configured, as shown in FIG. 18, as a vertical rectangular. Each vertical rectangular slants to a center line Y of the body 110a at a predetermined angle α₁, α₂, and the longitudinal line of each vertical rectangular is directed to the center line Y.

The cross member 114 hooked into the column 110 has a perpendicularly bent outer hook 115a at each longitudinal end of the web 114a. Each inner hook 116a has been provided between two slots 115a at a predetermined interval. The inner hook is bent in a same direction as the outer hook 115a, and is located at more inside position than the outer hook 115a.

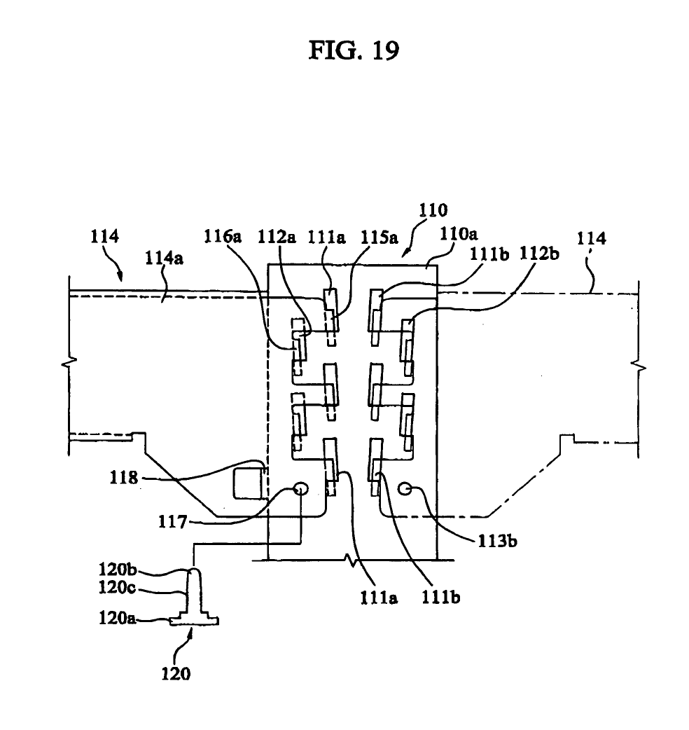

A hole 117 is formed at a lower corner of the web 114a, as shown in FIG. 19. The hole 117 is coaxial to any round opening 113a, 113b when the cross member 114 is assembled with the column 110. A perpendicularly bent location restrictor 118 is formed adjacent to the hole 117.

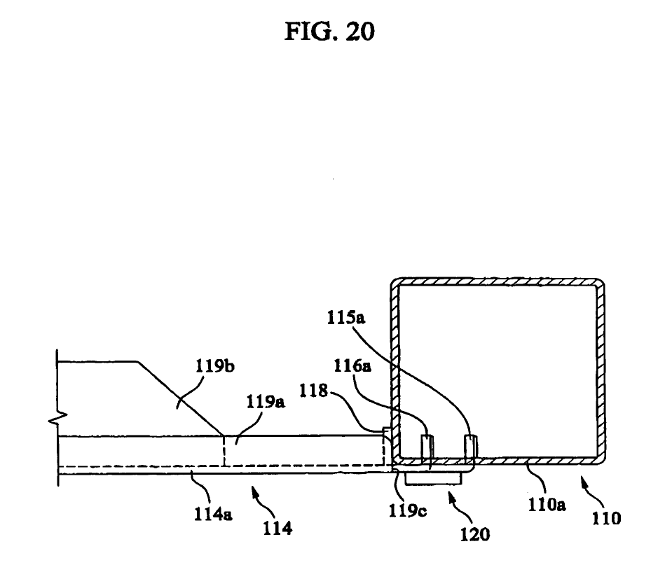

Shown in FIG. 20, the cross member 114 has a perpendicularly bent upper/lower horizontal flange 119a, 119b at each upper/lower longitudinal edge of the web 114a. A width of the upper horizontal flange 119a is narrower than that of the lower horizontal flange 119b. Furthermore, a cut-off member 119c is formed at each longitudinal end of the upper horizontal flange 119a.

A fixing pin 120 is screwed to any round opening 113a, 113b of the column 110 through a hole 117 of the cross member 114. The fixing pin 120 has a head 120a and a pin member 120b protruded from one end of the head 120a. In addition, a thread portion 120c is formed around the circumference of the pin member 120b.

The outer/inner hooks 115a, 116a are inserted into the inner/outer slots 111a, 112a which are arranged at one side to the center line Y (refers to FIG. 17). The outer/inner hooks 115a, 116a are pressed down, and the assembly is accomplished as shown in FIGS. 19 and 20.

Now, the cut-off member 119c and the location restrictor 118 are tightly contacted with the body 110a of column 110, which prevents the forward/backward and the right/left slight movement.

At this state, the pin member 120b of the fixing pin 120 is pressed into the round opening 130a of the column 110 through the hole 117 of the cross member 114, and the thread portion 120c is crushed, thus completing the assembly.

The fixing pin 120 can be inserted into the right or left side with respect to the center line Y of the body 110a depending on the installation direction of the cross member 114. Of course, the fixing pin 120 can be inserted into both sides with respect to the center line Y of the body 110a when each cross member 114 is assembled with the respective end of the column 110.

In the case of the disassembly of the column 110 and the cross member 114, a tool such as a flat driver is inserted into a gap between the head 120a of the fixing pin 120 and the outside surface of the cross member 114 so as to push aside the fixing pin 120. The fixing pin 120 can be pulled out from the round opening 113a and the hole 117.

Next, the cross member 114 is pushed upward so as to extract the outer/inner hook 115a, 116a from the outer/inner slot 112a, 111a. Thus, the cross member 114 is easily separated from the column 110.

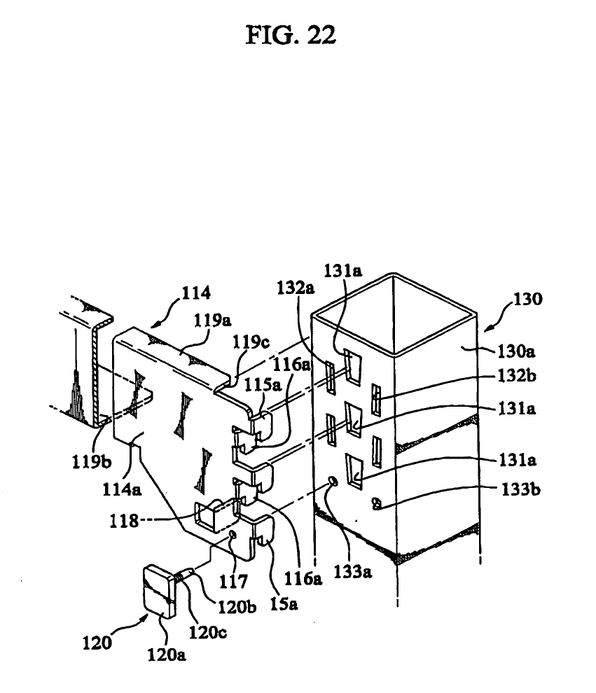

FIGS. 22 to 24 illustrate a sixth embodiment according to the present invention. This modifies a configuration of the inner/outer slot formed at the column 130 to properly adapt to a column having a relatively narrow width.

The trapesiform inner slot 131a is provided along the center line Y of the body in a longitudinal manner. The outer slots 132a, 132b are formed at each outside of the trapesiform inner slot 131a at a predetermined interval. Moreover, a pair of round opening 133a, 133b is provided below the lowest outer slots 132a, 132b.

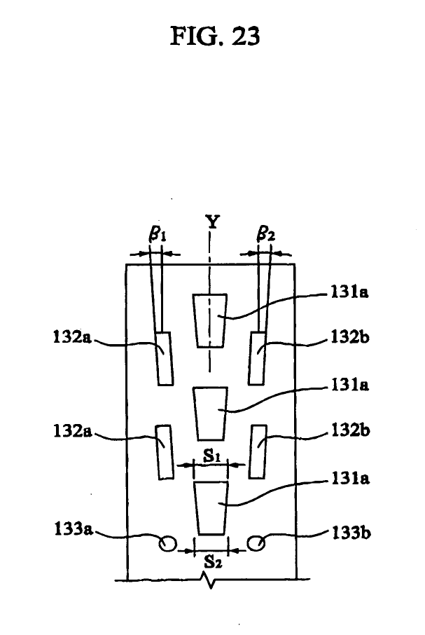

The inner slot 131a, as shown in FIG. 23, has a trapezoid shape, in which the upper side S₁ is longer than the lower side S₂. The outer slots 132a, 132b are configured in a vertical rectangular shape. Each vertical rectangular slants to a center line Y of the body 130a at a predetermined angle β₁, β₂, and the longitudinal line of each vertical rectangular is directed to the center line Y.

The cross member 114 and the fixing pin 120 are the same as those of the previous described embodiment. Therefore, the detailed description will be omitted for brevity, with denoting the same reference numerals of the same components described in the previous embodiment.

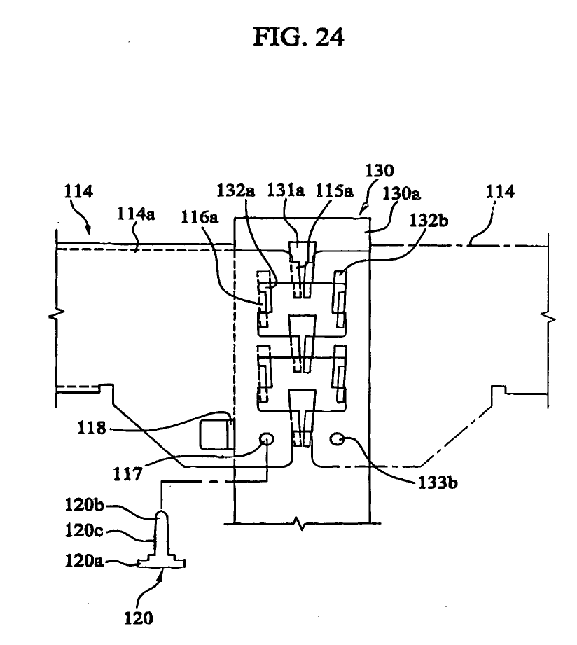

However, this embodiment has a difference in operation respect to the previous embodiment. That is, a pair of outer hook 115a of the cross member 114 can insert into one inner slot 13 la of the column 130 in an opposite direction as shown in FIG. 24.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

According to the present invention, the rectangular rack frame is accomplished by an assembly in which the column is fixed with the cross member utilizing minimum fastening means, thus securing simple and speedy assembly and disassembly. The coupling portion of both column and cross member has reinforcement, which causes more rigid assembly force than a prior art, and secures the isolation of a shaking of forward/backward, right/left direction and the structural stability. Also, it shows a satisfactory appearance.

Furthermore, in the present invention, it can able to possible that the manufacturing of each component can be done by a single process of cutting and bending, thus providing considerable effect in workability and productivity.

In the cross member, the flange, the location restrictor, and the upper horizontal flange can tightly contact with the outer surface of the column, and this brings the inventive rack frame by which a right/left movement can be perfectly prevented.

Furthermore, while the coupling of the column and the cross member depends on point contact in a prior art, in the present invention the hook of the cross member can surface-contact with the slot of the column to obtain big fastening force.

Therefore, according to the present invention, easy assembly and disassembly can be secured, and structure stability can be ensured by the isolation of forward/backward, left/right shaking of the components, and also the satisfactory appearance.

1. A prefabricating rack frame comprised of a column made of a steel square tube, a cross member made of a bent steel plate, by which a square is formed, and multiple shelf plates are placed, the prefabricating rack frame comprising;
the column having plural inner slots, and plural outer slots, in which the inner slots are longitudinally formed along a middle portion of at least one surface of the column, and are arranged in one or two row in the center, the outer slots are formed at the respective outer side of each line of the inner slot, and each outer slot is located between the upper and lower row of the inner slot at equal interval; and
the cross member having a vertical web, an upper/lower horizontal flange which are contacted on the outer surface of the column, and plural inner/outer hooks, the inner/outer hooks are formed at each longitudinal end of the vertical web and are rectangularly bent toward the extending direction of the horizontal flange, thereby each inner/outer shook hook is inserted into the inner/outer slot provided at any one side of the column, and is firmly engaged into the respective slot.

2. The prefabricating rack frame as set forth in claim 1, wherein the cross member further has a location restrictor formed at the inside of the inner hook and bent parallel to the upper horizontal flange, by which the location restrictor is fully contacted on the side surface of the column along the upper horizontal flange.

3. The prefabricating rack frame as set forth in claim 1, wherein the column has a pair of round openings formed at the outer side of each lowest inner slot in a parallel way, the vertical web has a hole which overlaps any of the round openings, in which the round openings and the hole are for engaging the column and the cross member by a screw.

4. The prefabricating rack frame as set forth in claim 1, wherein the inner slots are arranged in two vertical rows and in the form of the three horizontal rows along the upper and lower side, and the inner slots and outer slots have a vertical rectangular form and each bottom of the rectangular slants to the vertical center line of the once side of the column; and the inner/outer hook has the same incline as the inner/outer slot, thereby the hooks are fully contacted on the side surface of the slots.

5. The prefabricating rack frame as set forth in claim 1, wherein the inner slots are arranged in one vertical row and in the form of the three horizontal rows along the upper and lower side, and the inner slot has a trapezoid shape, in which the upper side is longer than the lower side, and the outer slots are configured in a vertical rectangular shape each of which inclines as the same slant of right/left side of the inner slot; and the inner/outer hook has the same incline as the inner/outer slot, thereby the hooks are fully contacted on the side surface of the slots.

6. The prefabricating rack frame as set forth in claim 1, wherein an inner vertical side of the inner/outer hook is inclined outward along the direction from top to bottom of the hook; and when each hook fits completely into the each slot, an inner vertical end of the inner/outer hook contraposes the an inner surface of the vertical web against a wall of the column so as to squash.

7. The prefabricating rack frame as set forth in claim 2, wherein each side end of the cross member—in which the inner/outer hook, the location restrictor and the a hole are provided—has a larger height than the middle portion of the cross member.

8. The prefabricating rack frame as set forth in claim 7, wherein at least one reinforcement bead is formed between each longitudinal end and the middle portion of the cross member.

9. The prefabricating rack frame as set forth in claim 7, wherein a lower boarder is provided between each longitudinal end and the middle portion of the cross member in a rolling circular arc.

10. The prefabricating rack frame as set forth in claim 2, wherein a rectangular opening is formed at the middle position of the vertical web, and each upper/lower part of the opening is bent at a right angle, which configures the location restrictor.

11. The prefabricating rack frame as set forth in claim 2, wherein a partial lower portion of the vertical web is bent at a right angle, which configures the location restrictor.

12. The prefabricating rack frame as set forth in claim 1, wherein a supporter having a depression is provided at each end of the upper horizontal flange, the supporter has a pair of traversal slots; a supporting member is nested on a pair of traversal slots.

13. The prefabricating rack frame as set forth in claim 12, wherein a stopper is provided at least two points of the cross member, and is configured as a partial cut-off of the upper horizontal flange at the border between the vertical web and the upper horizontal flange; the cut-off portion is stretched upward along the extending direction of the vertical web.

14. The prefabricating rack frame as set forth in claim 12, wherein the supporting member has a pair of hooks at each end thereof; each hook is inserted into the traversal slot so as to squash.

15. The prefabricating rack frame as set forth in claim 1, wherein the column has a pair of round openings formed at the outer side of each lowest inner slot in a parallel way, the vertical web has a hole which overlaps any of the round openings, in which a pin member of a fixing pin is screwed to any round opening through the hole, and the fixing pin has further a head which is fully contacted with the location restrictor.

16. The prefabricating rack frame as set forth in claim 15, wherein a thread portion is formed around the circumstance of the pin member, and the pin member has a fastigiated point.
